(19) United States
(12) Patent Application Publication
(10) Pub. No.: US 2004/0126293 A1
(43) Pub. Date: Jul. 1, 2004

(54) Process for removal of carbon dioxide from flue gases

(76) Inventors: Jacobus Johannes Cornelis Geerlings, Amsterdam (NL); Evert Wesker, Amsterdam (NL)

Correspondence Address: Yukiko Iwata, Shell Oil Company, Legal - Intellectual Property, P. O. Box 2463, Houston, TX, 77252-2463, US

(21) Appl. No.: 10/690,900

(22) Filed: Oct. 22, 2003

(30) Foreign Application Priority Data
Oct. 23, 2002 (EP) 02079415.2

(51) Int. Cl. B01D 53/62

(52) U.S. Cl. 423/228

(57) ABSTRACT

A process to removal and capture of carbon dioxide from flue gas is provided. Carbon dioxide is extracted from flue gas by contacting the flue gas with a solvent in a solvent extraction zone (1) to obtain a carbon dioxide-depleted flue gas, regenerating the solvent in a solvent regeneration zone (2) by heating the carbon dioxide-containing solvent to obtain a regenerated solvent and a carbon dioxide stream and reacting the carbon dioxide stream obtained in step (b) with a bivalent alkaline earth metal silicate in a mineral carbonation zone (3) by contacting the carbon dioxide stream with silicate particles dispersed in an aqueous solution.

### FIELD OF INVENTION

The present invention relates to a process for the removal of carbon dioxide from flue gas.

### BACKGROUND OF THE INVENTION

The rising of the carbon dioxide concentration in the atmosphere is causing needs to reduce the atmospheric carbon dioxide concentration.

A large part of the total carbon dioxide emission to the atmosphere is carbon dioxide contained in industrial flue gases. In a flue gas stream, carbon dioxide is present at low concentrations, typically at a carbon dioxide partial pressure between 50 and 150 mbar.

A technique that is generally used in industry to remove CO₂ from gas streams that contain carbon dioxide in such a low concentration is solvent extraction. See U.S. Pat. No. 1,783,901 and U.S. Pat. No. 1,934,472 for examples of solvent extraction. Solvent extraction involves exposing a carbon dioxide containing gas stream to a solvent, typically an aqueous amine solution, which reacts with the CO₂ in the gas in an acid-base reaction to yield a soluble carbonate salt according to:

2RNH₂+CO₂→RHN₃⁺+RNH—CO₂⁻ and/or

RNH₂+CO₂+H₂O→(RHN₃)⁺+HCO₃⁻

The solvent extraction reaction is reversible, allowing the solvent to be regenerated by heating.

A disadvantage of solvent extraction is the energy required for the regeneration of the solvent. For solvent extraction of carbon dioxide using an aqueous amine solution as solvent, 1.0 to 2.0 MJ/kg CO₂ is typically required for solvent regeneration.

Another disadvantage of solvent extraction is that the carbon dioxide stream obtained after solvent regeneration is at ambient pressure. Converting ambient pressure carbon dioxide to a form that is suitable for transport and sequestration is energy-consuming, since it would typically involve pressurizing carbon dioxide to high pressures.

Examples of carbon dioxide sequestering processes are the use of pressurised carbon dioxide for enhanced oil recovery or for the recovery of coal bed methane.

In view of the above, there is a need for a process enabling both the removal and capture of CO₂ from flue gas, that is less energy-consuming.

### SUMMARY OF THE INVENTION

A process for the removal of carbon dioxide from flue gas is provided comprising the steps of:

(a) contacting the flue gas with a solvent in a solvent extraction zone thereby extracting carbon dioxide from flue gas and providing a carbon dioxide-depleted flue gas and a carbon dioxide-containing solvent;

(b) heating said carbon dioxide-containing solvent to a solvent regeneration temperature and maintaining the solvent at said temperature in a solvent regeneration zone thereby regenerating the solvent and providing a regenerated solvent and a carbon dioxide stream; and

(c) contacting said carbon dioxide stream with silicate particles dispersed in an aqueous solution in a mineral carbonation zone said silicate particles being a bivalent alkaline earth metal silicate. Such process provides both the removal and capture of CO₂ from flue gas that is less energy-consuming.

### BRIEF DESCRIPTION OF THE DRAWINGS

The FIGURE is a schematic process diagram of one embodiment of the process of the invention.

### DETAILED DESCRIPTION OF THE INVENTION

We have now found that a novel process combining the steps of solvent extraction of carbon dioxide from flue gas, subsequent regeneration of the solvent while generating a carbon dioxide stream and reacting the carbon dioxide stream in a mineral carbonation step, offers considerable advantages over the processes known in the art to remove and capture carbon dioxide from flue gases. Thus, a process is provided for the removal and capture of carbon dioxide from flue gas comprising the steps of:

(a) extracting the carbon dioxide from flue gas by contacting the flue gas with a solvent effective to extract carbon dioxide from flue gas in a solvent extraction zone to obtain a carbon dioxide-depleted flue gas;

(b) regenerating the solvent in a solvent regeneration zone by heating the carbon dioxide-containing solvent to a solvent regeneration temperature and maintaining it at that temperature to obtain a regenerated solvent and a carbon dioxide stream; and

(c) reacting the carbon dioxide stream obtained in step (b) with a bivalent alkaline earth metal silicate in a mineral carbonation zone by contacting the carbon dioxide stream with silicate particles dispersed in an aqueous solution.

Reference herein to a flue gas is to a gas stream containing carbon dioxide in a low concentration, typically having a carbon dioxide partial pressure of at most 300 mbar, more usual between 50 and 150 mbar.

In the process according to the invention, a solvent extraction step, a solvent regeneration step and a mineral carbonation step are combined.

Conventional solvent extraction and solvent regeneration techniques can be used in the process of the invention. Preferred solvents for removal of carbon dioxide are aqueous solutions of one or more amine compounds. Typical examples are monoethanolamine, diethanolamine, triethanolamine, diglycolamine, methyldiethanolamine, or diisopropanolamine or a combination of two or more thereof. The aqueous amine solution typically contains between 15% and 35% by weight of amine, preferably between 20 and 30% by weight of amine based on the total weight of the solution.

The mineral carbonation step involves the exothermic reaction of carbon dioxide with silicates to form carbonate and silica according to:

(Mg,Ca)ₓSi_{y}O_{x+2y}+xCO₂→x(Mg,Ca)CO₃+_{y}SiO₂

The carbon dioxide stream obtained in the solvent regeneration step is contacted with silicate particles dispersed in water or an aqueous electrolyte solution. It will be appreciated that in such dispersion, part of the carbon dioxide will dissolve and may be partly present in the form of HCO₃⁻ or CO₃²⁻ ions.

In the process according to the invention, the heat released in the mineral carbonation step, i.e. step (c), is preferably used for the solvent regeneration step, i.e. step (b). Heat can be transferred by known heat transfer methods. Typically, steam is used as a heat transfer medium. With the heat released in step (c), superheated steam may be produced that is used in step (b), either via a heat exchanger or by direct injection of steam.

Preferably, at least 50%, more preferably at least 65% of the heat needed for step (b) is supplied by the heat released in step (c).

In order to be able to use the heat released in step (c) for step (b), the operating temperature in the mineral carbonation zone is preferably between 25° C. and 35° C. higher than the solvent regeneration temperature. The solvent regeneration temperature is preferably between 100° C. and 200° C., more preferably between 120° C. and 180° C. The skilled person will appreciate that the solvent regeneration temperature depends inter alia on the solvent used. The thermal stability of the solvent is one of the factors that has to be taken into account.

To maintain the preferred temperature difference between the operating temperature in the mineral carbonation zone and the solvent regeneration temperature, the operating temperature in the mineral carbonation zone is preferably in the range of from 140 to 200° C. In view of the preferred operating temperature in the mineral carbonation zone, it will be appreciated that the preferred operating pressure in the mineral carbonation zone is in the range of from 3 to 15 bar (absolute).

The carbon dioxide stream obtained in step (b) is preferably pressurized to the pressure prevailing in the mineral carbonation zone. Thus, the carbon dioxide stream obtained in step (b) is preferably pressurized to a pressure in the range of from 3 to 15 bar (absolute), more preferably in the range of from 5 to 13 bar (absolute), before being reacted with the silicate in the mineral carbonation zone in step (c). The preferred pressure range of from 3 to 15 bar (absolute) to which the carbon dioxide stream in the process according to the invention has to be pressurized is considerably lower than the pressure which would be needed to use the carbon dioxide sequestration in processes such as enhanced oil recovery or coal bed methane recovery.

In the mineral carbonation zone, CO₂ is brought into contact with an aqueous solution comprising dispersed silicate particles. This may be carried out in any reactor suitable for gas-solid reactions in the presence of a liquid. An example of a suitable reactor is a slurry bubble column.

Preferred bivalent alkaline earth metal silicates for the process of the present invention are calcium and/or magnesium silicates. Other metal ions, such as iron, aluminium, or manganese ions, may be present besides the bivalent alkaline earth metal ions. Especially in naturally-occurring silicates, both bivalent alkaline earth metal ions and other metal ions are present. An example is olivine which contains bivalent iron ions and magnesium ions. Examples of calcium and/or magnesium silicates suitable for the process according to the invention are forsterite, olivine, monticellite, wollastonite, diopside, and enstatite.

Ortho-, di- and ring silicates and silicates having a chain structure are preferred for the process of the invention. Phyllosilicates, which are silicates having a sheet structure, and tectosilicates, which have a framework structure, are less suitable for the process according to the invention.

It is preferred that the silicate particles dispersed in the aqueous solution are small in order to achieve a high reaction rate. Preferably, the silicates particles have an average diameter of at most 0.5 mm, more preferably at most 0.2 mm. Reference herein to the average diameter is to the volume medium diameter D(v,0.5), meaning that 50 volume % of the particles have an equivalent spherical diameter that is smaller than the average diameter and 50 volume % of the particles have an equivalent spherical diameter that is greater than the average diameter. The equivalent spherical diameter is the diameter calculated from volume determinations, e.g. by laser diffraction measurements.

It has been found that the reaction rate of the mineral carbonation reaction can be increased by adding an electrolyte to the water wherein the silicate particles are dispersed. Therefore, the silicate particles are preferably dispersed in an aqueous electrolyte solution. The electrolyte solution is preferably a solution of a salt that has a solubility in water of at least 0.01 moles per litre at 298K and 1 atmosphere, more preferably at least 0.1 moles per litre. Preferred salts are sodium, potassium or barium salts, more preferably chlorides or nitrates of sodium, potassium or barium salts, i.e. NaCl, KCl, BaCl₂, NaNO₃, KNO₃, or Ba(NO₃)₂, even more preferably sodium nitrate.

The electrolyte solution preferably has an electrolyte concentration of at least 0.01 moles/litres, more preferably in the range of from 0.1 to 2 moles per litre.

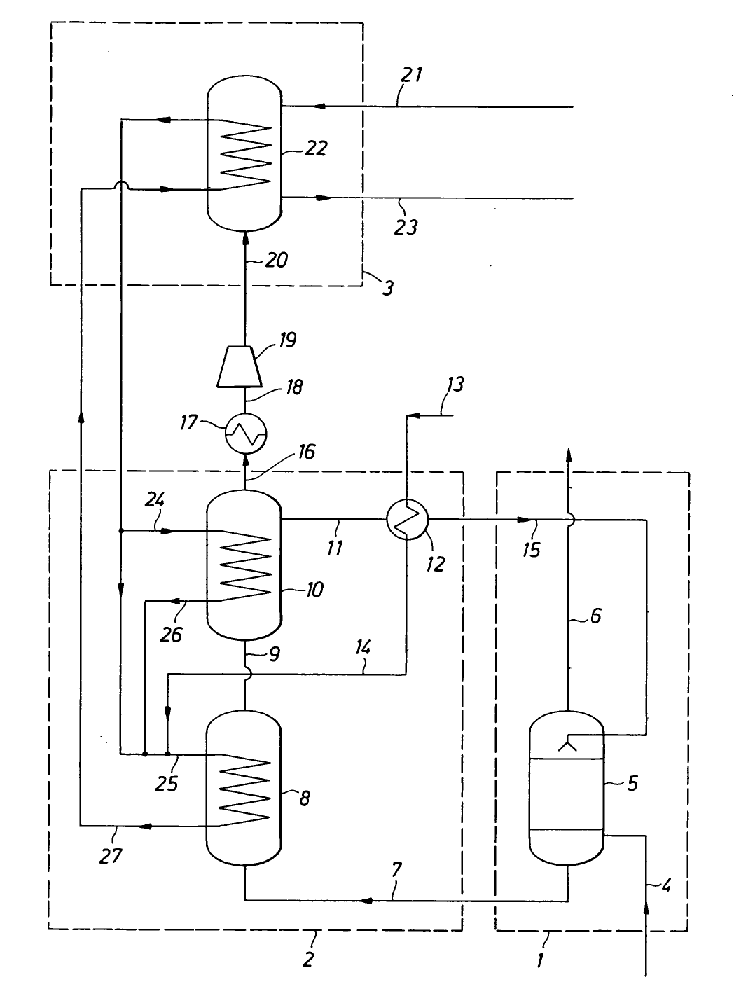

One embodiment of the invention will now be illustrated by means of schematic FIG. 1.

FIG. 1 depicts a preferred process scheme of the process according to the invention comprising solvent extraction zone 1, solvent regeneration zone 2 and mineral carbonation zone 3.

In solvent extraction zone 1, a flue gas stream containing carbon dioxide is introduced via line 4 into solvent extraction reactor 5. In one embodiment of the invention, an aqueous organic amine solution is present as solvent in solvent extraction reactor 5. The flue gas is intimately contacted with the solvent, thereby allowing the solvent to extract the carbon dioxide from the gaseous stream. The carbon dioxide-depleted flue gas is removed from solvent extraction reactor 5 via line 6.

The carbon dioxide-containing solvent is then led via line 7 to solvent regeneration zone 2 and introduced into solvent heating reactor 8. In reactor 8, the carbon dioxide-containing solvent is heated to the solvent regeneration temperature. The heated carbon dioxide-containing solvent is then led via line 9 to solvent regeneration reactor 10. In solvent regeneration reactor 10, the heated carbon dioxide-containing solvent is maintained at the solvent regeneration temperature to obtain a hot carbon dioxide stream and a hot regenerated solvent. The hot regenerated solvent is led via line 11 to heat exchanger 12, wherein it is condensed. Water is introduced via line 13 into heat exchanger 12 and heated to steam by the heat generated from the condensing reaction. The steam thus generated is led via line 14 to reactor 8. The condensed regenerated solvent is led via line 15 back into solvent extraction reactor 5.

The hot carbon dioxide stream obtained from the solvent regeneration reaction is led from reactor 10 via line 16 to cooler 17 wherein it is cooled. The cooled carbon dioxide stream is led via line 18 to compressor 19, wherein compression takes place. The compressed carbon dioxide stream is led via line 20 into mineral carbonation zone 3. In mineral carbonation zone 3, an aqueous stream comprising dispersed silicate particles is led via line 21 into mineral carbonation reactor 22. In the mineral carbonation reactor 22, they are reacted with carbon dioxide from the compressed carbon dioxide stream. The resulting products, comprising the captured carbon dioxide as carbonate compounds, are removed from mineral carbonation reactor 22 via line 23.

The heat released from the mineral carbonation reaction is used to generate superheated steam. The superheated steam is led via lines 24 and 25, respectively, to reactors 10 and 8, where it is used to maintain reactor 10 at the solvent regeneration temperature and to heat up reactor 8 to the solvent regeneration temperature. The cooled steam from reactor 10 is led via line 26 to reactor 8. The cooled down steam from reactor 8 is led via line 27 to mineral carbonation reactor 22.

The process of the invention will now be illustrated by means of the following illustrative embodiment, which is provided for illustration only and is not to be construed as limiting the claimed invention in any way.

In a process as shown in FIG. 1, a flue gas stream containing 75 mbar (partial pressure) carbon dioxide having a temperature of 50° C. is introduced via line 4 into solvent extraction reactor 5.

In solvent extraction reactor 5, an aqueous diethanolamine solution (25 wt % diethanolamine) is present as solvent. The flue gas is intimately contacted with the solvent, thereby allowing the solvent to extract the carbon dioxide from the gaseous stream. The carbon dioxide-depleted flue gas, containing 5 mbar (partial pressure) carbon dioxide and having a temperature of 55° C., is led from the solvent extraction reactor via line 6. The carbon dioxide-containing solvent at the bottom of reactor 5, having a temperature of 75° C., is then led via line 7 to the solvent regeneration zone 2 and introduced into the solvent heating reactor 8.

In reactor 8, the carbon dioxide-containing solvent is heated to 150° C. For this heating, 3 MJ/kg CO₂ is needed. The heated carbon dioxide-containing solvent is then led via line 9 to the solvent regeneration reactor 10. In the solvent regeneration reactor 10, the heated carbon dioxide-containing solvent is maintained at 150° C. to obtain a hot carbon dioxide stream and a hot regenerated solvent. In this regeneration reaction, 1.2 MJ/kg CO₂ is used. The hot regenerated solvent is led via line 11 to heat exchanger 12, wherein it is condensed and cooled down to 50° C. In the cooling down process, 4.0 MJ/kg CO₂ is generated. Part of this heat, 1.2 MJ/kg CO₂, is used to generate steam from the water introduced via line 13 into the heat exchanger 12. The remainder of the heat generated in the condensing reaction cannot be used. The steam thus generated, having a temperature of 130° C., is led via line 14 to reactor 8, where is used to maintain the reactor temperature of 150° C. The condensed regenerated solvent, having a temperature of 50° C., is led via line 15 back into the solvent extraction reactor 5.

The hot carbon dioxide stream, having a temperature of 150° C., obtained from the solvent regeneration reaction is led from reactor 10 via line 16 to a cooler 17 wherein it is cooled down to 50° C. at a pressure of 1 bar (absolute). The cooled carbon dioxide stream is led via line 18 to a compressor 19, wherein compression takes place to 10 bar (absolute). The compressed carbon dioxide stream, having a temperature of 180° C., is led via line 20 into a mineral carbonation zone 3. In mineral carbonation zone 3, a stream comprising dispersed calcium silicate particles in water is led via line 21 into the mineral carbonation reactor 22. The operating temperature of the mineral carbonation reactor is 180° C. The dispersed calcium silicate particles are reacted with carbon dioxide from the compressed carbon dioxide stream. In this reaction, 2.2 MJ/kg CO₂ is generated. The resulting products, calcium carbonate and siliciumdioxide compounds, are removed from the mineral carbonation reactor 22 via line 23.

The 2.2 MJ/kg CO₂ heat generated from the mineral carbonation reaction is used to generate superheated steam. The superheated steam, having a temperature of 170° C. and a pressure of 7 bar (absolute) is led via lines 24 and 25, respectively, to reactors 10 and 8, where it is used to maintain reactor 10 at the solvent regeneration temperature and to heat up reactor 8 to the solvent regeneration temperature. The cooled steam from reactor 10, having a temperature of 165° C., is led via line 26 to reactor 8. The cooled steam/water from reactor 8, having a temperature of 100° C., is led via line 27 to the mineral carbonation reactor 21. In this example, for the heating of the solvent in reactor 8, 3 MJ/kg CO₂ is needed and for the regeneration of the solvent in reactor 10, 1.2 MJ/kg CO₂ is needed. From the heat generated in the condensing reaction, 1.2 MJ/kg CO₂ heat can be used, so for the reactions in the solvent regeneration zone, an additional 3 MJ/kg CO₂ is needed. In the mineral carbonation zone, 2.2 MJ/kg CO₂ is generated and 2.0 MJ/kg CO₂ of this heat can be used for the reactions in the solvent regeneration zone.

Thus, in this example about 68% of the heat needed for the reactions in the solvent regeneration zone is supplied by the reactions in the mineral carbonation zone.

We claim:

1. A process for the removal of carbon dioxide from flue gas comprising the steps of:
(a) contacting the flue gas with a solvent in a solvent extraction zone thereby extracting carbon dioxide from flue gas and providing a carbon dioxide-depleted flue gas and a carbon dioxide-containing solvent;
(b) heating said carbon dioxide-containing solvent to a solvent regeneration temperature and maintaining the solvent at said temperature in a solvent regeneration zone thereby regenerating the solvent and providing a regenerated solvent and a carbon dioxide stream; and
(c) contacting said carbon dioxide stream with silicate particles dispersed in an aqueous solution in a mineral carbonation zone said silicate particles being a bivalent alkaline earth metal silicate.

2. The process of claim 1 wherein the heat released in step (c) is used in step (b).

3. The process of claim 1 wherein at least 50% of the heat needed for step (b) is supplied by the heat released in step (c).

4. The process of claim 1 wherein the temperature of contact in the mineral carbonation zone is in the range of 25° C. to 35° C. higher than the solvent regeneration temperature.

5. The process of claim 1 wherein the solvent regeneration temperature is in the range of from 100° C. and 200° C.

6. The process of claim 1 wherein the solvent regeneration temperature is in the range of from 120° C. and 180° C.

7. The process of claim 1 wherein the carbon dioxide stream obtained in step (b) is pressurized to a pressure in the range of from 3 to 15 bar (absolute), before being reacted with the silicate in the mineral carbonation zone.

8. The process of claim 1 wherein the contact temperature in the mineral carbonation zone is in the range of from 140 to 200° C.

9. The process of claim 1 wherein the solvent is an aqueous amine solution.

10. The process of claim 2 wherein the solvent is an aqueous amine solution.

11. The process of claim 4 wherein the solvent is an aqueous amine solution.

12. The process of claim 9 wherein the solvent is selected from the group consisting of an aqueous solution of monoethanolamine, diethanolamine, triethanolamine, diglycolamine, methyldiethanolamine, diisopropanolamine, and a combination of two or more thereof.

13. The process of claim 10 wherein the temperature of contact in the mineral carbonation zone is in the range of 25° C. to 35° C. higher than the solvent regeneration temperature.

14. The process of claim 10 wherein the solvent regeneration temperature is in the range of from 100° C. and 200° C.

15. The process of claim 14 wherein the solvent is selected from the group consisting of an aqueous solution of monoethanolamine, diethanolamine, triethanolamine, diglycolamine, methyldiethanolamine, diisopropanolamine, and a combination of two or more thereof.

16. The process of claim 1 wherein the bivalent alkaline earth metal silicate is a magnesium or calcium silicate.

17. The process of claim 1 wherein the silicates particles have an average diameter of at most 0.5 mm.

18. The process of claim 11 wherein the silicates particles have an average diameter of at most 0.2 mm.

19. A process for the removal of carbon dioxide from flue gas comprising the steps of:
(a) contacting the flue gas with a solvent effective to extract carbon dioxide from flue gas in a solvent extraction zone thereby extracting carbon dioxide from flue gas and providing a carbon dioxide-depleted flue gas and a carbon dioxide-containing solvent;
(b) heating said carbon dioxide-containing solvent to a temperature in the range of from 100° C. and 200° C. and maintaining the solvent at said temperature in a solvent regeneration zone wherein at least 50% of the heat needed is supplied by the heat released in step (c) thereby regenerating the solvent and providing a regenerated solvent and a carbon dioxide stream; and
(c) contacting said carbon dioxide stream with silicate particles dispersed in an aqueous solution in a mineral carbonation zone said silicate particles being a bivalent alkaline earth metal silicate.

20. The process of claim 19 wherein the solvent is an aqueous amine solution.
